(19) United States
(12) Patent Application Publication
(10) Pub. No.: US 2006/0059117 A1
(43) Pub. Date: Mar. 16, 2006

(54) Policy managed objects

(76) Inventors: Michael Tolson, Corte Madera, CA (US); Andrew L. Dale, Berkeley, CA (US)

Correspondence Address: Ken Buchanan, 7 Castillo, Irvine, CA, 92620-1828, US

(21) Appl. No.: 10/944,441

(22) Filed: Sep. 17, 2004

Related U.S. Application Data
(60) Provisional application No. 60/610,086, filed on Sep. 14, 2004.

(51) Int. Cl. G06F 17/30

(52) U.S. Cl. 707/2

(57) ABSTRACT

System and method provides a mechanism to control access to a data object and to the data within the object. A policy managed object comprised policy objects, a payload container object for securely storing a payload with data, and a number of interfaces that provide access to the policy managed object and the payload. When a user invokes an interface in order to request the performance of an operation on the policy managed object or the payload, policies associated with the requested operation and the policy manage object are invoked. The policies determine, based on executable instructions, whether the requested operation can be allowed under the circumstances. If the policies determine that the operation can be allowed, the operation is performed. Otherwise, the operation is not performed and access to the policy managed object and payload is denied.

### PRIORITY INFORMATION

This application claims the benefit of U.S. Provisional Application No. __/______, Attorney Docket No. CJB.005PR, entitled “POLICY MANAGED OBJECTS,” which was filed Sep. 14, 2004. The foregoing provisional application is hereby incorporated in its entirety by this reference.

### FIELD OF THE INVENTION

Embodiments of the invention relate to controlling access to data.

### BACKGROUND OF THE INVENTION

Computer networks transmit a large amount of data. Many computer users desire to secure computer data such that unauthorized users or processes cannot access the data. Many conventional ways to provide data security, however, are not sufficiently flexible or powerful. For example, data security mechanisms that rely on permissions lists have limited usefulness. Permissions lists typically associate a set of permissions with a grouping of data, such as a file. A set of permissions typically specifies a number of users or groups of users that can read, write, or execute a file. Such permissions, being predefined and fixed, are sometimes not flexible enough to address the complex security needs for a particular computer network.

### SUMMARY OF THE INVENTION

Embodiments of the systems and methods described herein provide a mechanism to associate data access policies with objects. As used herein, the term “object” is a broad term meant to encompass, in addition to its ordinary meaning in the context of computer data, any data structure that includes data and has associated operations for acting on the data. The data access policies reside in the object itself or, in some embodiments, reside in one or more remote locations. Herein, objects that are capable of having associated data access policies are known as policy managed objects. The data access policies are hereinafter referred to as policies. Advantageously, each policy is defined by executable instructions that reside within an object known herein as a policy object. This provides a great degree of flexibility for designing policies for controlling access to data that are appropriate to the particular needs of a computer network. Additionally, policy managed objects advantageously securely store and/or manage data of any arbitrary data type. For example, an arbitary data type can include other objects. Advantageously, therefore, policy managed objects provide a mechanism to provide security and access control for types of data that typically have not been secure. Tools are provided for easily loading any type of data into a policy managed object for this purpose.

Preferably, each policy managed object comprises a number of interfaces for accessing the object and the data inside the object. Herein, the data within a policy managed object is known as the payload. In certain embodiments, the interfaces advantageously provide the only mechanisms by which access to the object or the payload are achieved. Restricting access in this way allows the systems described herein to ensure that all of the policies are executed before allowing access to the objects or payload.

Preferably, the payload is securely stored within a payload container object. Preferably, a payload container object encrypts the payload such that the payload cannot be read by an unauthorized user, even if the user succeeds in separating the payload from the policy managed object. The payload container object preferably does not decrypt the payload or allow access to the payload without being provided with appropriate means to decrypt the payload. A skilled artisan will appreciate, in light of this disclosure, that a number of effective encryption and decryption technologies exist and that any of these technologies can be used for securing the payload and for providing an appropriate decryption means. Additionally, a skilled artisan will appreciate, in light of this disclosure, that developments in encryption and decryption technologies are likely to occur and that such developments can advantageously be incorporated into the embodiments described herein. Accordingly, the invention is not limited to the use of any particular encryption or decryption technology. Preferably, policies enable access to the payload container object only if the policies determine that access to the policy managed object or the payload is allowed. In one embodiment, the policies enable access to the payload container object by providing the payload container object with an appropriate means to decrypt the payload. Moreover, in certain embodiments, the policies require authentication, such as, for example, authentication by login and password pairs, digital certificates, token, biometric thumbprint, iris scan, any other authentication technique known in the art, or any subset or combination of the foregoing.

One embodiment of the invention is a data object comprising at least one payload, a number of interfaces, and at least one policy object. The payload comprises data or optionally other objects. Hereinafter, the term “data,” as used to describe that which the payload stores, encompasses both data as commonly understood and optionally other object. Each interface is configured to perform at least one operation on the data object. No operation can be performed on the data object except by invocation of one of the interfaces. Each policy object comprises executable instructions configured to make a determination as to whether at least one operation requested to be performed on the object is allowed. One embodiment also has at least one payload container object. The payload container object is configured to securely store the payload such that the payload cannot be operated upon without approval from the payload container. The payload container object optionally securely stores the payload by encrypting the payload. The payload container object optionally decrypts the payload and approves an operation that is requested to be performed on the payload upon receiving a valid decryption key or other form of authentication as described above.

In one embodiment, the payload container object grants a request to perform an operation on the payload upon a determination from at least one policy object that the requested operation is allowed. In the foregoing embodiments, the payload container object preferably receives a valid decryption key from a policy object when the policy object determines that a requested operation is allowed.

Advantageously, a policy object optionally defines conditions that can be tested in order to assist the policy object to determine whether a requested operation is allowed to be performed on a policy managed object. Additionally, a policy object is optionally configured to receive input from at least one service. In such cases, the input from the service contributes at least partially to resolving whether conditions defined by the policy object are satisfied.

Advantageously, in certain embodiments, policy objects are nestable and composeable. As such, a policy object can comprise within the policy object at least one other policy object.

Another embodiment of the invention is an execution context for managing data objects. The execution context comprises a storage area for storing policy managed objects and a plurality of access tools for accessing the policy managed objects. Preferably, the policy managed objects have the characteristics described above with regard to the foregoing embodiments. In one embodiment, the policy managed objects stored in the storage area comprise at least one payload container object, a number of interfaces, and at least one policy object. The payload container object stores at least one payload comprising data. Each interface is configured to perform at least one operation on the policy managed object. Advantageously, no operation is allowed to be performed on the policy managed object except by invocation of one of the interfaces. The policy object comprises executable instructions configured to make a determination as to whether at least one operation requested to be performed on the policy managed object is allowed. The access tools are configured to cause at least one operation to be performed on at least one of the policy managed objects.

The access tools of the foregoing embodiment optionally include a policy editor configured to create and modify policy objects. Creating and modifying policy objects includes composing or nesting multiple policy objects together so as to define a composed policy object. The access tools optionally also include an object editor configured to create and modify policy managed objects. Creating and modifying policy managed objects includes loading data of arbitrary type into the payload container object. The access tools are also optionally configured, in response to receipt of a request to perform an operation on an identified policy managed object, to invoke an interface of the identified policy managed object that is configured to perform the requested operation.

The execution context of any of the foregoing embodiments is optionally configured to recognize lifecycle occurrences that happen to the policy managed objects. Such lifecycle occurrences include, for example, object connection, object activation, object serialization, object copy, object delete, and other lifecycle occurrences. In response to a lifecycle occurrence, the execution context notifies all objects accessible to the execution context that the lifecycle occurence has happened, and the objects preferably respond to this notification according to each object's programming. Policy managed objects preferably, therefore, are programmed to execute their policies on the basis of such notifications. For example, a policy can be programmed to execute on object activation, and if approprite conditions are not met, to refuse to complete activation.

In any of the foregoing embodiments, the access tools can include at least one communication interface configured to provide access to at least one service that is configured to return at least one input that influences the policy object's determination as to whether at least one operation requested to be performed on the policy managed object is allowed.

Another embodiment of the invention is a method of controlling access to a data object. The method comprises receiving a request to perform an operation on a data object, invoking an interface that corresponds to the operation to be performed on the data object, executing at least one policy that corresponds to the interface, determining, based on the execution of the at least one policy, whether performing the requested operation on the data object is allowed, and performing the requested operation on the data object if the requested operation is allowed. In this method the policy that is executed optionally is defined at least in part by executable instructions included in the policy object. Furthermore, the policy object that defines the policy that is executed optionally resides within the data object upon which the operation is to be performed. Additionally, determining whether performing the requested operation on the data object is allowed optionally comprises determining whether at least one condition defined by the policy is satisfied. Moreover, determining whether performing the requested operation on the data object is allowed optionally further comprises receiving input from a service.

These embodiments and others described herein advantageously provide a flexible and powerful mechanism for controlling access to a data object and any data in the data object. A more detailed description of these and other embodiments, by way of illustration and not limitation, is provided with reference to the drawings.

### BRIEF DESCRIPTION OF THE DRAWINGS

FIG. 1 is a block diagram illustrating one embodiment of a policy managed object.

FIG. 1A is a block diagram and tree illustrating how policy managed objects, in one embodiment, comprise a number of nestable and composable objects.

FIG. 2 is a block diagram illustrating one embodiment of an execution context configured to operate upon the policy managed objects of FIG. 1.

FIG. 3 illustrates a number of simplified policies that can be used with the policy managed objects of FIG. 1.

FIG. 4 illustrates a number of simplified lifecycle occurrence methods that can be used to invoke the policies of FIG. 3.

FIG. 5 is a block diagram illustrating one usage of the policy managed objects of FIG. 1 to ensure that a user has an unexpired license before allowing access to content.

FIG. 6 is a flowchart illustrating a process of controlling access to data using the policy managed objects of FIG. 1.

### DETAILED DESCRIPTION OF THE PREFERRED EMBODIMENT

Generally, embodiments of the systems and methods described herein provide flexible and powerful mechanisms for controlling access to a data object and any data within the data object. Such mechanisms are useful to increase network security, to ensure that only authorized users have access to data objects, to enforce rules about when objects can be accessed, from what location objects can be accessed, with what tools objects can be accessed, and the like.

To aid understanding, meanings for certain terms used herein are provided below.

This application refers at times to “accessing” a policy managed object, or to “accessing” data within a policy managed object. As used herein, “accessing” a policy managed object or data includes performing any operation on the policy managed object or the data. Accordingly, a user or automated process is able to access a policy managed object or the object's data by viewing the data, editing the data, annotating the data, copying the object, deleting the object, or any other operation that can be performed on an object or on data.

The term “user,” as used herein, includes any agent that requests actions, whether the agent is human or not. Accordingly, a user can be a human, an automated process, an application program, or the like. A skilled artisan will appreciate, in light of this disclosure, that even actions performed by a human user on a computer are most often ultimately performed by an application program or automated process, in that the computer generally invokes an automated process to carry out a human user's instructions.

Additionally, embodiments described herein can be implemented within a computing environment. As such, the systems described herein can be implemented as software running on hardware, as firmware, as hardware, or as some combination of the foregoing. Preferably, the systems described herein are implemented at least in part in software, or, more specifically, using a plurality of software modules, functions, procedures, objects, and the like. In this regard, the embodiments described herein are generally described using block diagrams, with individual blocks illustrating separate functional units of the overall systems. While it is possible to implement the embodiments described herein in a way that each functional unit depicted in the drawings is a separate software module, such a design is only one implementation. A skilled artisan will appreciate, in light of this disclosure, that functional units can be designed in a wide variety of ways. For example, a skilled artisan will appreciate, in light of this disclosure, that the many functional units described herein can in fact be implemented using a single module. Alternatively, the many functional units described herein can be implemented using multiple modules, but with some of the functional units combined into single modules.

Policy Managed Objects

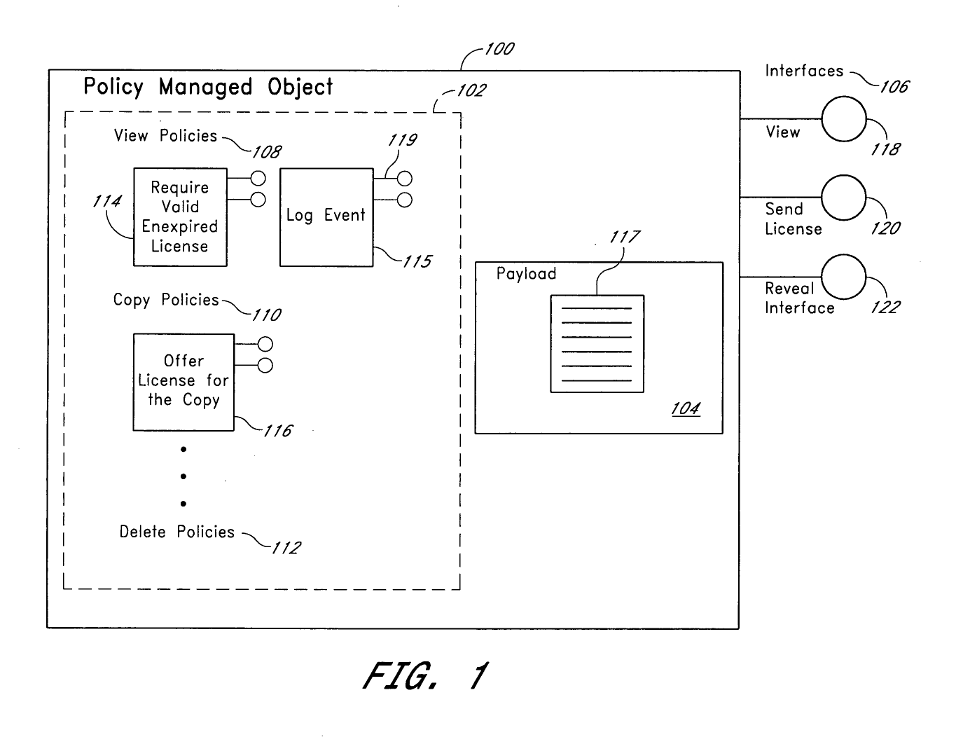

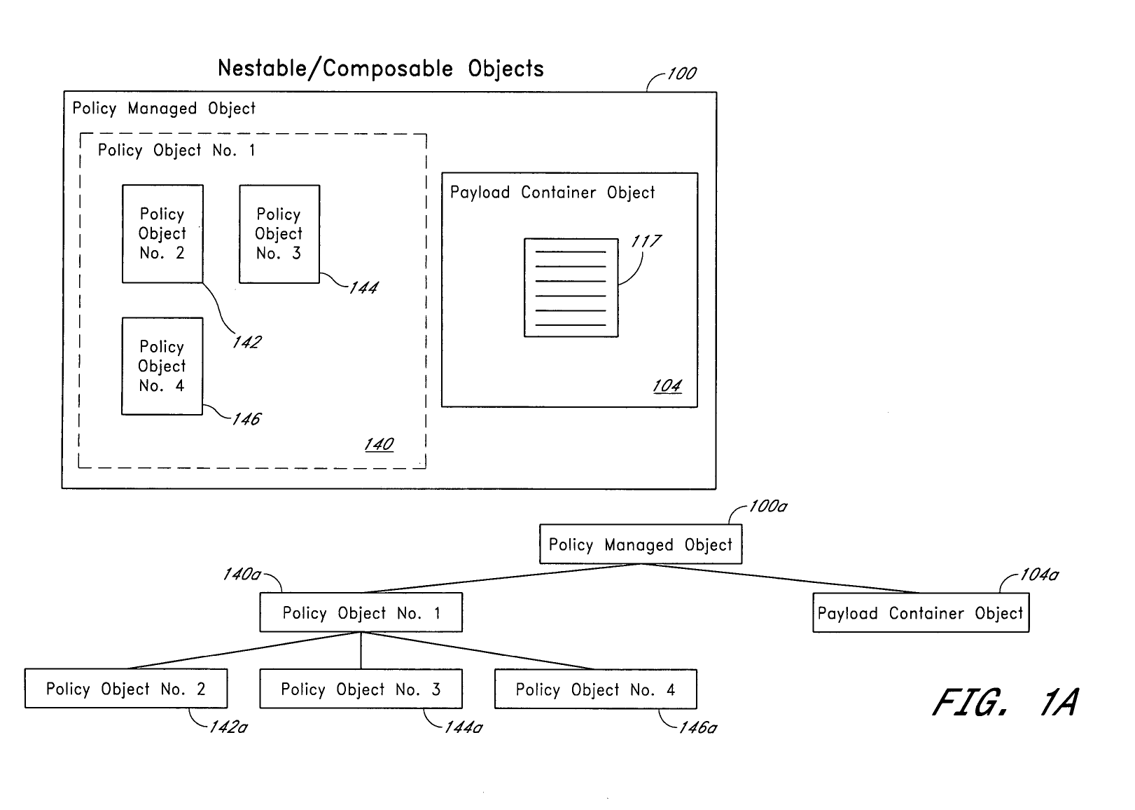

FIG. 1 is a block diagram illustrating one embodiment of a policy managed object. Preferably, a policy managed object 100 comprises one or more policies 102, a payload container object 104, and one or more interfaces 106. The policies 102, the payload container object 104, and the interfaces 106 cooperate to control access to the policy managed object 100 and to the data that resides within the policy managed object 100. The data residing within the policy managed object 100 is known as the payload 117, and, in one embodiment, resides, preferably securely, in the payload container object 104. Alternatively or additionally, the payload 117 resides at least partially at a location that is outside the payload container object 104. In cases in which at least a portion of the payload 117 resides outside the payload container object 104, the payload container object 104 preferably comprises a reference to the payload 117. The payload 117 comprises arbitrary data of any type which may include, for example, a Word document, a spreadsheet file, a database file of any format, a media file such as an MPEG movie file, an email message, a collection of raw bytes, an object, or any other type of data. Preferably, the interfaces 106 provide exclusive access to the policy managed object 100 and the payload 117. This means that the interfaces 106 are the only recognized means to access the policy managed object 100 or the payload 117 and that the policies 102 and the payload container object 104 cooperate in order to prevent any access that does not go through the interfaces 106.

A manner in which the policies 102, the payload container object 104, and the interfaces 106 interact, according to one embodiment, in order to cooperatively secure the payload 117 against unauthorized access is now described. Preferably, the payload container object 104 securely stores the payload 117 by, for example, storing the payload 117 in encrypted form. Preferably, the payload container object 104 does not release the payload 117 unless presented with a valid authentication for decrypting the encrypted payload 117. In this manner, the payload container object 104 can act as a gatekeeper to prevent unauthorized access to the payload 117 but allow authorized access. In this context, the presentation of a valid authentication signifies authorized access while a failure to present a valid authentication signifies unauthorized access. Advantageously, encrypting the payload 117, in most cases, prevents unauthorized users from reading the contents of the payload 117 even if the users are able to separate the payload 117 from the payload container object 104.

As indicated, in one preferred embodiment, the interfaces 106 provide the only recognized means for accessing the policy managed object 100 or the payload 117. Preferably, the interfaces 106 comprise well-defined and generic mechanisms for accessing the payload 117 in some way and for performing operations associated with such access. FIG. 1 illustrates several interfaces 106 by way of example and not limitation. A View interface 118, for example, can be configured to view the contents of the payload 117. For example, if the payload 117 comprises a media file such as an MPEG movie file, the View interface 118 can request for the movie file to be played using a media player that supports the MPEG movie format. A Send License interface 120 can be configured to allow a user to send a license for accessing the payload 117. Such a Send License interface 120 can be useful with regard to commercial media such as movies and music that a copyright owner may want to distribute only under license in order to maximize revenue. In cases where a user attempts to view content for which the user has not already presented a license, the user may be required, by a policy, for example, to present a valid license. In such a case, the user can invoke the Send License interface 120 in order to provide the license and gain access to the payload 117.

FIG. 1 also illustrates a Reveal Interfaces interface 122. Preferably, each policy managed object 100 provides a Reveal Interfaces interface 122, which can be configured to interact with a user or automated process to communicate information about the interfaces 106 of the policy managed object 100. Advantageously, by providing a Reveal Interfaces interface 122, any user or automated process can learn how to interact with the policy managed object 100 upon first encountering the policy managed object 100. Each user and automated process, therefore, need not remember the interfaces of all types of policy managed objects that exist. It can be expected that users and automated processes may frequently encounter unfamiliar policy managed objects, so it is preferable and advantageous to provide a mechanism for revealing the interfaces of each policy managed object. A skilled artisan will appreciate, in light of this disclosure, that the name of such a mechanism for revealing interfaces does not need to be “Reveal Interfaces.” It is preferable, however, that one particular interface name is reserved exclusively for the purpose of revealing the interface of any policy managed object, such that users and automated processes can know with uniformity how to find out how to interact with a particular policy managed object. A skilled artisan will appreciate, in light of this disclosure, that many mechanisms for communicating interface information are known in the art.

Access Mediated by Formal Transactions

Advantageously, providing such interfaces allows access to an object or to the payload of an object to be mediated according to formal transactions. As used herein, a formal transaction is essentially a well-defined dialogue between a user or automated process on the one hand, and a policy managed object on the other hand. The user or automated process communicates with the policy managed object through its interfaces. The interfaces define a manner in which the communication proceeds. For example, an interface may be invoked when a user desired to view a video clip within an object payload. The interface may define a dialogue in which the interface requests a license from the user or the automated process. The user or automated process then responds by presenting the license. The license is then verified. At each step, the interface defines what information is expected from the user or automated process and communicates with the user or automated process accordingly. Therefore, providing interfaces for communication with a policy managed object organizes all user and automated process interactions with a policy managed object into well-defined and orderly formal transactions.

Controlling Access with Interfaces and Policies

Advantageously, by providing the exclusive means to access the policy managed object 100 or the payload 117, the interfaces 106 are able to ensure, in cooperation with the policies 102, a high level of control and security regarding access to the policy managed object 100 and the payload 117. In one preferred embodiment, the interfaces 106 cooperate with the policies 102 to provide such security. Preferably, the execution of an interface 106 causes the execution of one or more associated policies 102 that determine whether or not access through the interface 106 is allowed. As illustrated, for example, the policy managed object 100 has a number of view policies 108. Such view policies 108 can be associated with the View interface 118 such that the view policies 108 execute whenever a user attempts to view the payload 117 by invoking the View interface 118. In the illustrated example, when a user attempts to view the payload 117, which may be a movie file, the view policies 108 that execute require that the user have a valid license to the payload 117, as indicated by the Require Valid Unexpired License policy 114. Furthermore, as indicated by the Log Event policy 115, the view policies 108 cause the user's attempted viewing of the payload 117 to be recorded in a log. A skilled artisan will appreciate, in light of this disclosure, that the foregoing policies are provided by way of example only and not limitation.

Preferably, each policy 102 tests one or more conditions in order to determine whether allowing access to the policy managed object 100 and the payload 117 is appropriate under the circumstances. Executable instructions within each policy 102 define the conditions to be tested by that policy 102 and acceptable results of the tests. In one embodiment, the executable instructions can define conditions to be tested by referring to information stored in memory, tables, databases, or another known data structure, whether such data structure is located within the policy managed object 100 or outside the policy managed object 100. Preferably, any condition that can be tested and measured in accordance with executable instructions can be tested. By way of illustration and not limitation, examples of conditions that can be tested by a policy follow. According to one example condition, a policy can require a user to have a license to view a media file such as an MPEG movie file. According to another example condition, a policy can require a secure message to be read on a secure computer. Such a condition can be useful useful, for example, to prevent a user from accessing sensitive documents from a public computer in, for example, a library. According to another example condition, a policy can require that a sensitive document can be accessed for only one hour. Advantageously, according to one embodiment, such conditions can be combined, such that, for example, a policy can require a secure message to be read on a secure computer and only for one hour.

Preferably, as illustrated, each policy 102 has one or more policy interfaces 119 that define a mechanism for interacting with and invoking the policy 102. Such policy interfaces 119 define such mechanisms for interaction in a manner similar to how the interfaces 106 define mechanisms for interacting with the policy managed object 100 in general.

Advantageously, allowing the testing of any condition or multiple conditions that can be defined using executable instructions allows policies 102 to be wholly or partially user-definable. In some embodiments, in addition to or in place of user-definable policies, a finite number of predefined policies are provided. Providing predefined policies can be advantageous, particularly with regard to commonly used policies, to allow users to create or modify policy managed objects quickly without requiring a lot of time to define policies. While user-definability of the policies 102 is an advantageous aspect of some embodiments, user-definability is not necessary to all embodiments.

For ease of explanation, if the results upon execution of one of the policies 102 are acceptable, as defined by the executable instructions of the policies in combination with any information from memory, tables, databases, or other data structures referenced by the executable instructions, then that policy 102 is deemed to be “okay.” If the results upon execution of one of the policies 102 are not acceptable, then that policies 102 is deemed to be “not okay.” For example, for a policy that requires a document to be opened only during business hours, from, for example, 9:00 am to 6:00 pm, one tested condition is that the time at opening must be between 9:00 am to 6:00 pm. If, upon policy execution, the policy determines that the time is 10:30 am, then this policy is deemed to be “okay.” If, on the other hand, the policy determines that the time is 8:00 pm, then this policy is deemed to be “not okay.” Note, as illustrated by this example, that the use of the terms “okay” and “not okay” in this application does not mean that the policies 102 only test boolean conditions or return results in boolean form.

Advantageously, the conditions that the policies 102 test are defined by the executable instructions of the policies 102. The tested conditions can be as simple or as complex as desired, subject only to designing the executable instructions and any information to which they refer properly. A skilled artisan will appreciate, in light of this disclosure, that more than one policy can execute with regard to an action requested by a user or automated process. These policies 102 can be nested, composed, or they may otherwise interact with each other to make a final determination about whether the policies 102 as a whole are ultimately deemed to be okay. One way to have the policies 102 make such a final determination is to have one root policy include the other policies 102, to have the root policy receive information from the included policies 102, and to have the root policy, based on the information received from the included policies 102, make the final determination concerning whether the policies 102 are okay. For example, a composite policy that includes five sub-policies may be deemed to be okay if three out of five of the sub-policies are individually okay. As another example, a composite policy that includes Policy A, Policy B, and Policy C may designate Policy A as a high-priority policy that overrides Policy B and Policy C. Accordingly, in this example, the composite policy is deemed to be okay when Policy A is okay, even if both Policy B and Policy C are not okay. Yet another example is that a composite policy may be deemed to be okay only if every one of the sub-policies is individually okay. A skilled artisan, in light of this disclosure, will appreciate that the use of executable instructions within each policy allows for great flexibility in making a determination regarding whether the policies 102 are okay.

In the event that the policies 102 are okay, the policies 102 cause the payload container object 104 to be presented with a valid authentication such that the payload container object 104 decrypts the payload 117 and makes the payload 117 accessible. In the event that the policies 102 are not okay, the policies 102 do not present a valid authentication to the payload container object 104, and the payload container object 104 denies access to the payload 117.

While the interfaces 106 preferably rely on the policies 102 to define access control to the policy managed object 100 and the payload 117, it is by no means essential for the policies 102 alone to serve this function. In some embodiments, for example, access control logic can be included in the policy managed object 100 itself. Alternatively or additionally, the policies 102 and the interfaces 106 can share access control responsibilities, such that some access control logic is included in the interfaces 106, but that the interfaces 106 still cause appropriate policies 102 to execute. In still other embodiments, in which security is not seen as a high priority, a designer of a policy managed object may choose to design interfaces 106 that have little or no access control logic and that also do not cause any policy 102 to execute, or cause a policy 102 to execute that approves access to the payload 117 without requiring the satisfaction of any real condition. A skilled artisan will appreciate, in light of this disclosure, that embodiments in which the interfaces 106 include a great deal of access control logic rather than allowing the policies 102 to perform this role are not favored. Nevertheless, such embodiments are within the scope of the invention described herein.

A skilled artisan will appreciate, in light of this disclosure that a number of authentication, encryption, and decryption techniques are known in the art and that any of these known techniques can be implemented in order to carry out the foregoing authentication, encryption, and decryption functionality.

Secure Containment of Arbitrary Data Types

Advantageously, a policy managed object 100 as described herein provide a way to securely contain data of an arbitrary data type. That is, preferably data of any data type, including for example, Word documents, spreadsheet files, text files, database records, raw bytes, other objects, or the like, can be loaded by a user or an automated process into the payload container object 104 of the policy managed object 100. Upon being loaded into the payload container object 104, such data becomes the payload 117 of the payload container object 104. Advanteously, once arbitrary data is loaded into the payload container object 104 of the policy managed object 100, access to the data is subject to the policies 102 of the policy managed object 100. Accordingly, a user can provide enhanced security and access management to arbitrary data, even for data formats that do not provide their own security, by loading the data into a payload container object 104. Tools for loading such data into a payload container object 104 are described below in another section of this application.

Additionally, the policy managed object 100 can provide secure containment of arbitrary data without knowing anything about the format of the data. Preferably, however, the policy managed object 100 does know the format of the data. Some policies, in fact, may depend on knowing the format of the data in order to operate correctly. For example, one policy pertaining to a Word document checks the Word metadata concerning the file to determine which users have previously edited the file and allows only those users that have previously edited the file to further access the file.

Composability and Nestability of Policy Objects

As previously indicated, the policies 102 of the policy managed object 100 are composeable and nestable to an arbitrary level. FIG. 1A illustrates this composability and nestability. The illustrated policy managed object 100 comprises a first policy object 140, a second policy object 142, a third policy object 144, a fourth policy object 146, and a payload container object 104. The payload container object 104 comprises a payload 117.

FIG. 1A includes a tree illustrating the structural relationship between the objects that make up the policy managed object 100. As indicated, the policy managed object 100 is represented by a policy managed object node 100a which is, as illustrated, the root node of the tree. Accordingly, the policy managed object 100 illustrated in FIG. 1A is a parent object that comprises children objects. Thus, as illustrated, the children of the policy managed object 100 are the first policy object 140, represented on the tree by a first policy object node 140a, and the payload container object 104, represented on the tree by a payload container object node 104a. The first policy object 140 is a parent object that has children objects of its own. Thus, as illustrated, the children of the first policy object 140 are the second policy object 142, represented on the tree by a second policy object node 142a, the third policy object 144, represented on the tree by a third policy object node 144a, and the fourth policy object 146, represented on the tree by a fourth policy object node 146a.

Distributed Policies

While FIGS. 1 and 1A illustrate the policies 102 as being within the policy managed object 100, some or all of the policies 102 can be distributed. Accordingly, a policy that is required by the policy managed object 100 may be located on an external server on a computer network. Advantageously, providing distributed policies can increase security even above the level provided by policies within the policy managed object 100. A skilled artisan will appreciate that many technologies exist for distributing policy objects and other objects across a computer network. Similarly, many network topologies exist that can be used to support such distributed policies, including, for example, peer-to-peer networking, client/server networking, and the like.

Execution Context

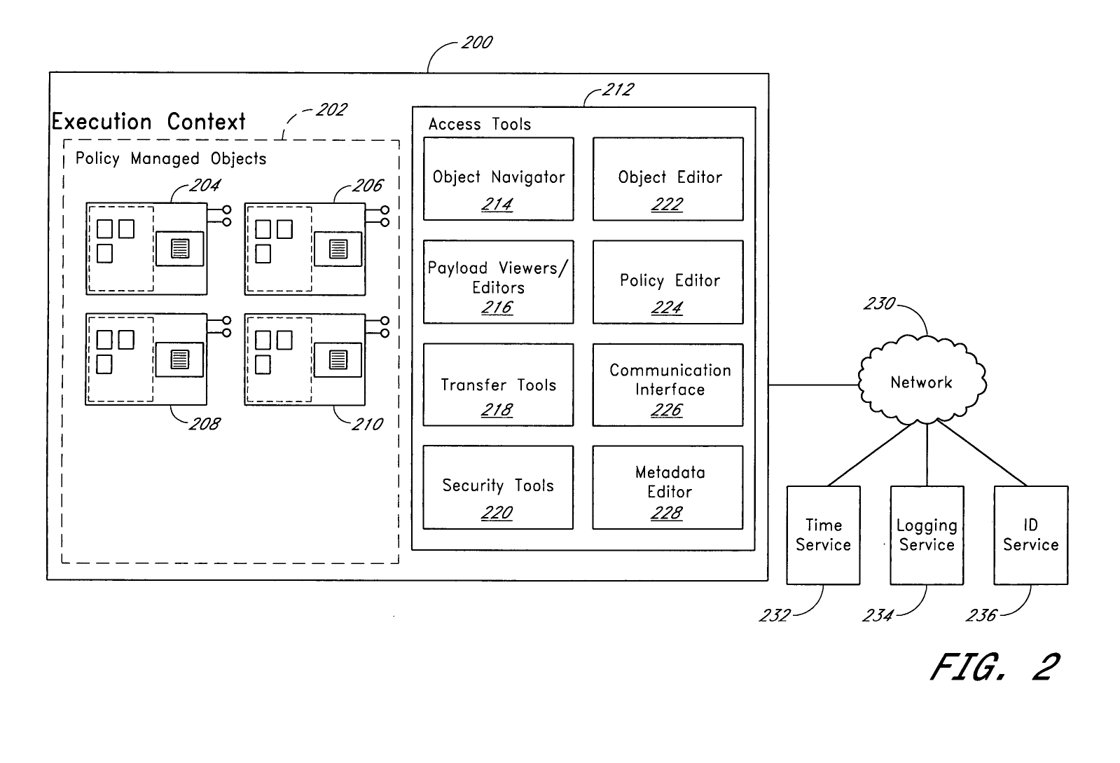

In one embodiment, the policy managed object 100 can only be activated, accessed, and otherwise operated upon within an execution context. FIG. 2 is a block diagram illustrating one embodiment of an execution context in which a policy managed object can be accessed. Preferably, the execution context 200 generally comprises one or more computer applications that are configured to interact with policy managed object interfaces, to access policy managed objects, and to perform operations on policy managed objects such as, for example, moving, copying, transferring, creating, editing, deleting, and the like. Preferably, the execution context 200 has access, through a computer network 230, to various services, including, for example, a time service 232, a logging service 234, an identification service 236, and other services that will be appreciated by a skilled artisan in light of this disclosure. Preferably, the execution context 200 is configured to operate on an operating system of a computer or computing device. Preferably, an execution context is provided for a variety of operating systems, including for example, Windows operating systems, Unix operating systems, the MacOS, OS/2, Linux, and the like, such that policy managed objects can be access and operated upon across computing platforms.

As illustrated in FIG. 2, the execution context 200 particularly comprises a storage area 202 for policy managed objects and access tools 212. The storage area 202 is a location in which a number of policy managed objects reside, and can be implemented in memory, in disk storage, files, database records, any other known mechanism for storing data objects, and or any combination of the foregoing. As illustrated, policy managed objects 204, 206, 208, and 210 reside in the illustrated storage area 202. While the storage area 202, as illustrated, resides within the policy managed object 100, alternatively or additionally at least a portion of the policy objects are stored outside of the policy managed object 100. In cases in which at least a portion of the policy objects are stored outside of the policy managed object 100, the storage area 202 provides a reference to the externally stored portions of the policy objects and a service for accessing such externally stored portions.

Generally, the access tools 212 comprise a number of tools for accessing and operating upon policy managed objects. Generally, the access tools 212 perform operations on policy managed objects such as activating, creating, opening, deleting, transferring, copying, editing, and the like.

A number of exemplary access tools 212 are described. A skilled artisan will appreciate, in light of this disclosure, that other access tools, in addition to those described, can be provided, without departing from the scope of this invention. Further, a skilled artisan will appreciate that not every described access tool must be provided in every embodiment, that the access tools 212 can be combined such that fewer access tools perform the same functions, and that the access tools 212 can be divided such that more access tools perform the same functions.

An object navigator 214 provides a user interface for viewing the policy managed objects 204, 206, 208, and 210 that reside in the storage area 202. The object navigator 214 can, for example, display a list of the policy managed objects 204, 206, 208, and 210, allow a user to sort the list, provide folders or directories for organizing the policy managed objects 204, 206, 208, and 210, allow a user to move and copy the policy managed objects 204, 206, 208, and 210 among such folders or directories, or the like. Additionally, the object navigator 214 preferably provides a user interface for indicating operations to be performed on the policy managed objects 204, 206, 208, and 210, such as, for example, opening an object, viewing an object, deleting an object, or the like. The object navigator 214 preferably includes features common to similar navigation applications that are provided in conventional operating systems. Such features are known to a skilled artisan and it is expected that they can be easily implemented by a skilled artisan in light of this disclosure.

Payload viewers and editors 216 comprise tools for viewing and editing the payload of a policy managed object. Such payload viewers and editors 216 include, for example, media players for playing media files, text editors including word processors for editing textual portions of a payload, graphics editors, and the like.

Transfer tools 216 comprise tools for performing operations on a policy managed object such as moving, deleting, copying, transmitting the object over a network, and the like.

Security tools 218 comprise tools for encrypting data, decrypting data, providing sign on and authentication, and the like. Preferably, the security tools 218 assist in securing the payload of a policy managed object within the payload container object by encrypting the payload. Preferably, the security tools 218 also assist in decrypting the payload when policies governing access to the payload are okay.

An object editor 222 allows a user to create or edit a policy managed object. Preferably, the object editor 222 provides a user interface that allows a user to design, graphically or otherwise, a policy managed object. Preferably, for example, the object editor 222 provides drag-and-drop functionality, such that a user can drag icons representing policies onto a graphical representation of a policy managed object, thereby adding the dragged policies to the policy managed object. Similarly, in one embodiment, the object editor 222 allows a user to drag a data item, such as, for example, a document, a file, a database record, or the like, onto a policy managed object, thereby adding the data item to the payload of the policy managed object.

A policy editor 224 allows a user to create or edit a policy. Preferably, the policy editor 224 has access to predefined policies that can provide the basis for a newly created or modified policy. Preferably, the object editor 222 provides a user interface for composing and nesting policies. For example, in one embodiment, the object editor 222 allows a user to drag-and-drop a graphical representation of a first policy onto a graphical representation of a second policy, thereby creating a third policy in which the first policy is a child of the second policy. Preferably, the object editor 222 also provides a textual editing capability, such that a user can edit, for example, executable instructions of a policy that defines the policy.

Communications interfaces 226 allow the execution context 200 to communicate with a network 230. This gives the execution context 200 access to services including, for example, a time service 232, a logging service 234, and an identification service 236.

A metadata editor 228 provides tools for editing object metadata.

A skilled artisan will appreciate, in light of this disclosure that the foregoing access tools 212 are provided herein by way of example and not limitation. Additional tools can be provided without departing from the scope of the invention. Furthermore, in some embodiments of an execution context, some of the described access tools 212 can be omitted. For example, in an execution context designed for accessing objects but not for creating or editing objects, the execution context may omit the object editor 222 and the policy editor 224. As illustrated, the access tools 212 reside, in one embodiment, within the execution context 200. Alternatively or additionally, the access tools 212, or some of them, reside outside of the execution context 200.

Exemplary Policies

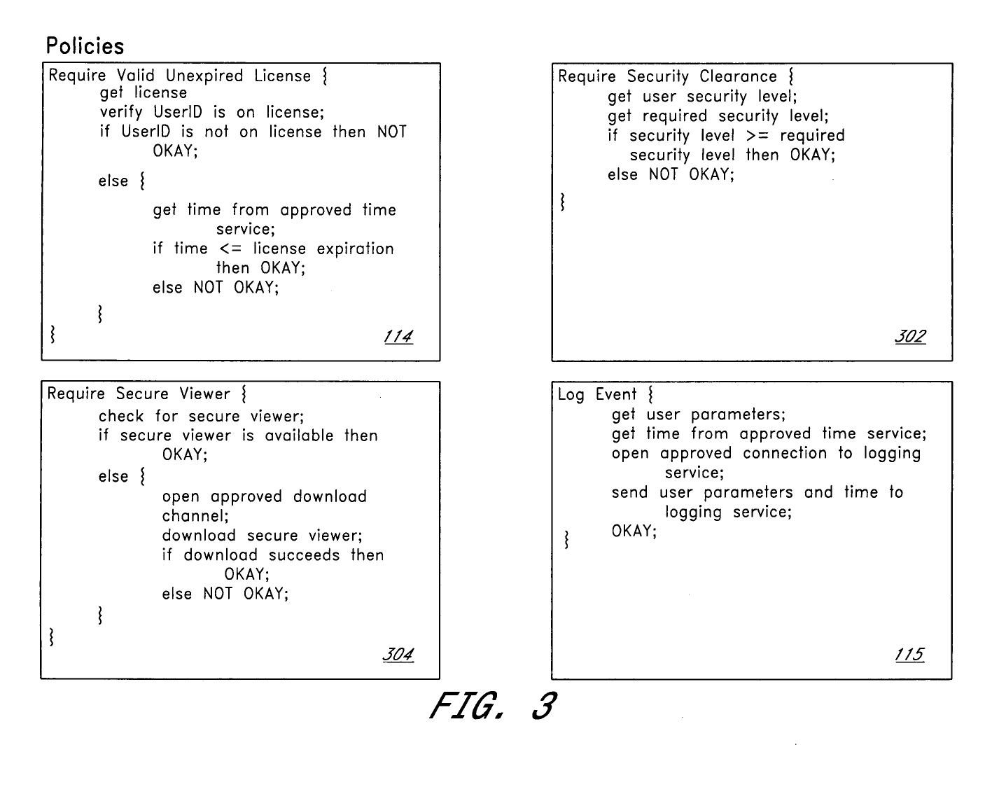

FIG. 3 illustrates a number of exemplary policies that can be used to manage access to a policy managed object as described herein. The exemplary policies 114, 302, 304, and 115 are illustrated using pseudocode to indicate the functions they perform. Additionally, the example policies 114, 302, 304, and 115 illustrate that the policies of a policy managed object comprise executable instructions to define the policy. Advantageously, the ability to define a policy using executable instructions, among other features of policies, sets policies as described herein apart from conventional permissions lists. Advantageously, for example, a policy can test much more complex conditions than do conventional permissions-based access control mechanisms.

For illustration in the exemplary policies 114, 302, 304, and 115, “OKAY” indicates that the policy has determined that the policy conditions have been met. “NOT OKAY” indicates that the policy has determined that the policy conditions have not been met. As previously explained, when the policy conditions have been met and the policy is okay, the policy allows access to policy managed object to which it pertains. Note, however, as has also been explained, that when more than one policy pertains to a policy managed object, the fact that one policy is okay does not guarantee that access to the policy managed object is allowed.

The exemplary policies 114, 302, 304, and 115 also illustrate that, in some embodiments, a policy may access a service in the course of execution. For example, the Require Valid Unexpired License policy 114 accesses an approved time service in order to get the current time with which to determine whether a license has or has not expired. A time service, as used herein, is a service that provides a current time and date. Such services may be internal, as in, within the same computer as the execution context of the policy, or external, as in, on another computer located on a computer network.

Each of the exemplary policies 114, 302, 304, and 115 are explained in turn. The Require Valid Unexpired License policy 114 is okay if the user attempting to access an object has a valid and unexpired license to the object. This example policy can be used to verify that a user requesting to play a media file has purchased or otherwise obtained a valid license to play the file. The policy 114 gets the license and verifies that the UserID of the requesting user appears on the license. If not, the policy 114 is not okay. Otherwise, the policy 114 connects to an approved time service to get the current time. If the current time is earlier than the expiration time of the license, then the policy is okay. If the license has expired, the policy is not okay.

The Require Security Clearance policy 302 is okay if a user requesting to access an object has a security level that is greater than or equal to a required security level for accessing the object. This policy 302 can be used to protect highly sensitive documents and other data by marking the data with a high security level. Thus, a highly sensitive document may be marked with a security level of 10, meaning, for example “executives eyes only,” while a document that can safely be released to the public may be marked with a security level of 0, meaning, for example, “freely distributable.” As illustrated, the exemplary Require Security Clearance policy 302 operates as follows. The policy 302 gets the requesting user's security level. The policy 302 then gets the required security level associated with the object that the user is attempting to access. The policy 302 then compares the user's security level to the required security level. If the policy 302 determines that the user's security level is greater than or equal to the required security level, the policy 302 is okay. Otherwise, the policy 302 is not okay.

The Require Secure Viewer policy 304 is okay if the user wanting to access an object has available, on the user's computer, a secure viewer. This policy 304 is useful for requiring users to view highly secure documents, such as those that should not be copied, on a secure viewer with limited capabilities. A secure viewer enhances security because a secure viewer, for example, may have certain features, such as cut-and-paste, disabled. This prevents a user from electronically copying data out of the secure viewer. The policy 304 operates as follows. The policy 304 checks to see if a secure viewer is available. If a secure viewer is available, the policy 304 is okay. This particular policy 304 does not give up, however, if a secure viewer is not available. Instead, the policy 304 opens an approved download channel. The policy 304 may access one of the communications interfaces 226 of FIG. 2 in order to accomplish this function. The communications interface 226 may connect to a network site that has a secure viewer available for download. The policy 304 attempts to download a secure viewer. If the download succeeds, the policy 304 is okay. Otherwise, the policy 304 is not okay.

The Log Event policy 115 illustrates a policy that does not test any conditions. Indeed, a skilled artisan will appreciate from the exemplary pseudocode of the policy 115 that the Log Event policy 115 always is okay. Thus, this policy 115 does not in any case prevent access to an object. Instead, this policy 115 accomplishes a function that may be important in certain circumstances; the policy 115 logs an access to an object. The policy 115 gets user parameters. The user parameters preferably identify which user has attempted to access an object. The policy 115 gets the current time from an approved time service. The policy 115 opens an approved connection to a logging service. The policy 115 may interact with the communications interfaces 226 of FIG. 2 in order to accomplish this function. The policy 115 sends the user parameters and the time (retrieved from the time service) to the logging service. As indicated, the policy 115, as always, is okay. The fact that the policy 115 is always okay does not mean that no policy at all secures the object to which the policy 115 pertains from unauthorized access. Indeed, in many cases, a logging policy such at this policy 115 exists within an object alongside another policy, such as the Require Valid Unexpired License policy 114. In such a case, the Require Valid Unexpired License policy 114 enforces proper security, while the Log Event policy 115 merely records the event in a log.

Policy Execution Upon Lifecycle Occurrences

In one preferred and advantageous embodiment, certain policies within a policy managed object can be associated with lifecycle occurrences. A lifecycle occurrence can be any occurrence that happens to a policy managed object during the lifecycle of the object. The lifecycle of the object is from the time the object is created to the time the object is destroyed. Preferably, the execution context 200 detects when lifecycle occurrences happen. Preferably, the lifecycle occurrences monitored by the execution context 200 include, for example, object connection, object disconnection, object activation, object deactivation, object serialization, object deserialization, object copy, and object delete. Furthermore, the invocation of any interface, such as the View interface 118, can be a lifecycle occurrence that can cause the execution of policies associated with the invocation of the associated interface (such as, for example, the View interface 118).

As used herein, object connection comprises connecting an object to a parent object. In one embodiment, only objects that are connected to a parent object can be activated such that they can be accessed. The execution context provides a root object that does not need to be connected to a parent. Object disconnection comprises disconnecting an object from a parent object. Object activation comprises making an object active. In one embodiment, only active objects can be accessed using policy managed object interfaces. Accordingly, object activation results in making an object accessible. Object deactivation comprises making an object inactive and therefore not accessible. As indicated, in one embodiment an object must be connected before the object can be activated. Object serialization comprises converting an object to a string of bits that can be moved from one context to another. Object serialization allows an object to be device-independent, such that the object can be read on any device that has an execution context. Object deserialization comprises converting a serialized object from a string of bits back to a form recognized by a device-specific execution context. Object copy and object delete comprise performing copy and delete operations as commonly understood by a skilled artisan.

FIG. 1 illustrates a number of policies 102 that are associated with certain lifecycle occurrences. For example, a number of view policies 108, associated with the invocation of the View interface 118, include the Require Valid Unexpired License policy 114 and the Log Event policy 115. A number of copy policies 110, associated with any attempt by a user to copy an object, include an Offer License for the Copy policy 116. The policy managed object 100 also has a number of policies associated with other lifecycle events, including, for example, delete policies 112. These other policies associated with other lifecycle events are not illustrated.

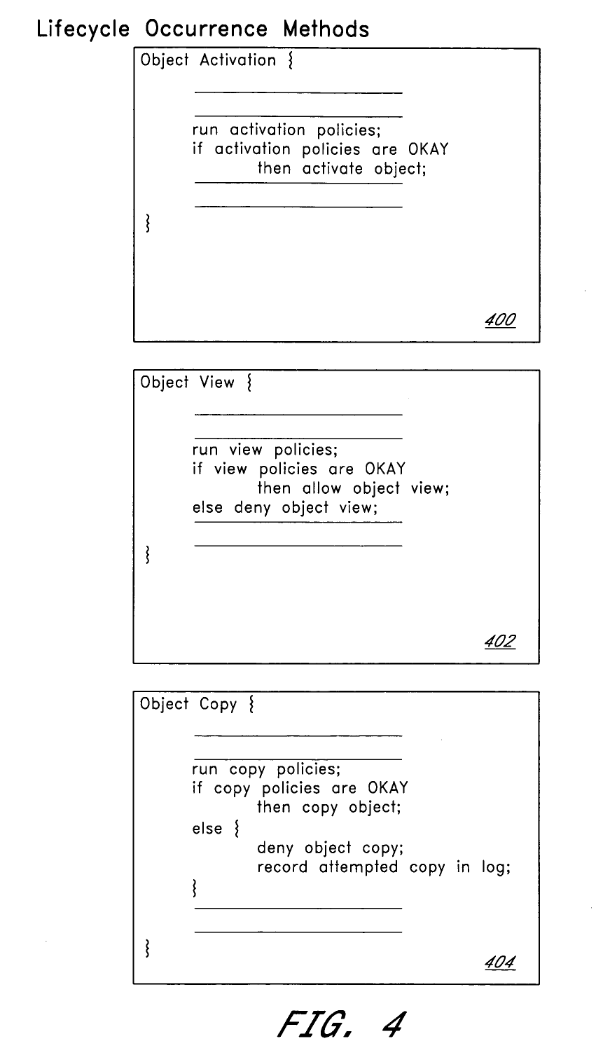

In one embodiment, whenever a lifecycle occurrence happens, a corresponding lifecycle occurrence method is invoked. Preferably, each lifecycle occurrence method, in turn, invokes any policies within the object that are associated with the lifecycle occurrence. FIG. 4 illustrates, using pseudocode, a number of lifecycle occurrence methods. An Object Activation lifecycle occurrence method 400 is executed when a user or automated process attempts to activate an object. As illustrated, the method 400 executes a plurality of instructions, some of which are not shown. Preferably, among the instructions, are instructions that cause any activation policies associated with the policy managed object to be run. After the policies are run, if the policies, on the whole, are okay, the object is activated. An Object View lifecycle occurrence method 402 operates in similar fashion. The method 402 runs any policies within the object that are associated with the viewing of the object. If the view policies, on the whole, are okay, then the user is allowed to view the object. Otherwise, the user is not allowed to view the object. An Object Copy lifecycle occurrence method 404 operates in similar fashion. In this case, however, the method 404 records any failed object copy attempts in a log.

Preferably, the execution context 200 informs each policy managed object 100 that is accessible to the execution context 200 when lifecycle occurrences happen. In one embodiment, the execution context 200 informs each policy managed object 100 by invoking, on each policy managed object 100, an interface configured to perform the notification. Each policy managed object 100 determines an appropriate response to the lifecycle occurrence, in accordance with the policies of the policy managed object 100. For example, when an object activation lifecycle occurrence happens to a particular policy managed object 100, the particular policy managed object 100 preferably invokes any policies associated with object activation of the policy managed object 100 by invoking an object activation lifecycle occurrence method.

A skilled artisan will appreciate, in light of this disclosure, that the lifecycle occurrence methods of FIG. 4 are exemplary only and not limiting on the invention. Lifecycle occurrence methods can perform additional functions that those performed. In some preferred embodiments, the lifecycle occurrence methods cause the invocation of policies that are associated with each lifecycle occurrence. Lifecycle occurrence methods are not required, in every instance, however, to invoke such policies. Furthermore, a skilled artisan will appreciate, in light of this disclosure, that not every policy managed object needs to have a policy for each lifecycle occurrence.

Dynamic Nature of Policies

Advantageously, according to some embodiments, the policies described herein are dynamic. This means, for example, that a policy associated with the policy managed object 100 can be modified by the creator of the policy managed object 100, even after the policy managed object 100 has been distributed to one or more other users. For example, a user Alice may create a policy managed object that provides that a user Bob can access the object for three days. However, one day after allowing Bob to access the object, Alice may decide to change the policy such that Bob can no longer access the policy for three days, but only for the next three hours. Alice can accomplish this change in Bob's ability to access the object by substituting a new policy object that defines a policy providing Bob access for three hours in place of the old policy objedt that defines a policy providing Bob access for three days. As another example, Alice can modify an existing object that requires a license but does not keep a log of accesses to an object such that the object not only requires a license but also keeps a log of accesses. Advantageously, such a change can be made, in one embodiment, simply by adding an additional policy object to a policy managed object.

In one embodiment, the creator of a policy managed object initially has control over the policy managed object's policies, such that the creator initially can define policies, modify policies, delete policies, add policies, and the like. Embodiments of the execution context 200 provide tools that allow a creator of a policy managed object to transfer such control to one or more other users. For example, in one embodiment a user Alice, the creator of an object, can transfer control of the object to Bob so that Bob can modify the policies related to the object. In one embodiment, a user can transfer certain aspects of control of an object, such as adding or modifying policies to the object, while maintaining other aspects of control, such as deleting the object.

Example of How Policy Managed Objects Control Access to Data

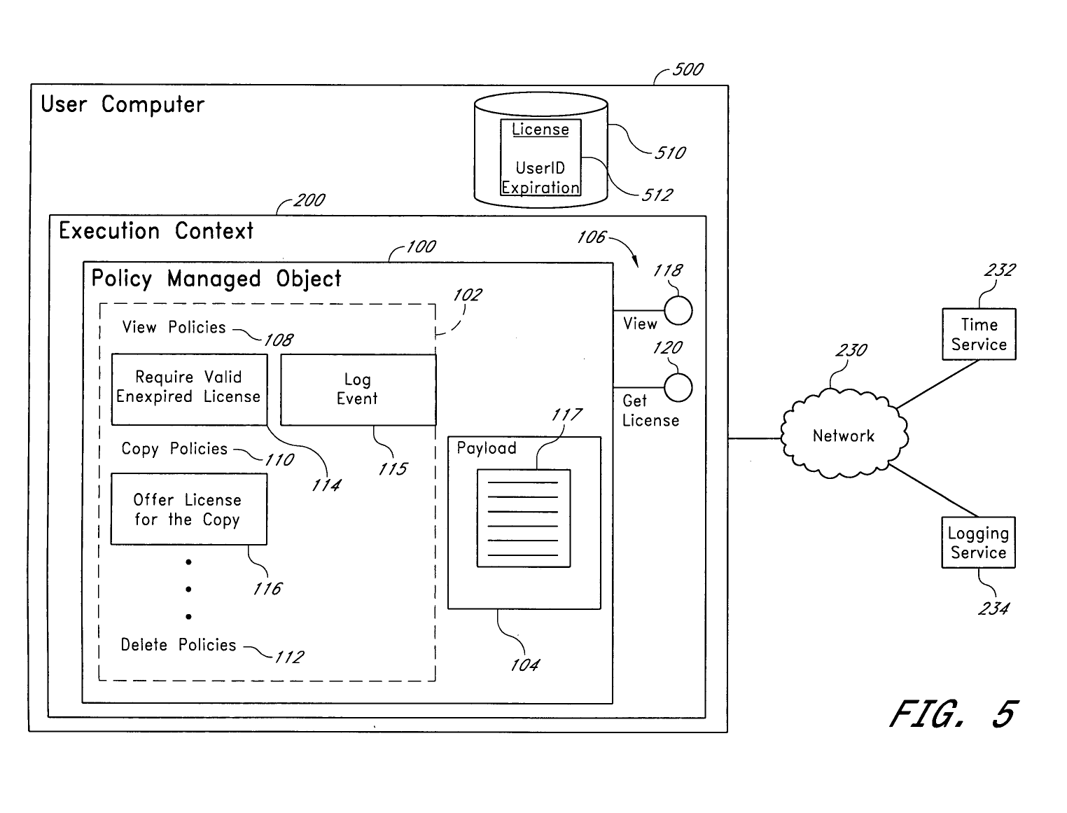

FIG. 5 is a block diagram illustrating an example of how a policy managed object can be used to control access to data. In particular, FIG. 5 illustrates an example in which a user attempts to view a movie clip stored within the payload container object 104 of the policy managed object 100. As illustrated, in this example the user's computer 500 has an execution context 502 and disk storage 510 storing a license 512. The execution context 502 has access to the policy managed object 100. The payload 117 of the payload container object 104 comprises a movie clip. The user's computer 500 upon which the execution context 502 resides is connected to a network 230 that has access to a remote time service 232 and a remote logging service 234.

Steps that occur in an exemplary process in which the user attempts to view the movie clip are described. Using tools provided by the execution context 502, the user requests to play the movie clip that resides in the payload container object 104. The user's action causes the invocation of the View interface 118 of the object 100. The View interface 118 of the object 100 comprises the only way recognized by the object 100 to access the payload 117 for the purpose of viewing the movie clip residing therein. The invocation of the View interface 118 causes a lifecycle occurrence related to viewing the payload 117. This causes the execution of a lifecycle occurrence method such as the Object View method 402 of FIG. 4. The Object View lifecycle occurrence method 402 runs any view policies associated with the object 100. As indicated in FIG. 5, these policies for the illustrated object are the Require Valid Unexpired License policy 114 and the Log Event policy 115.

As illustrated by FIG. 3, the Require Valid Unexpired License policy 114 gets the license 512, which in this example is stored on the user's computer 500. The policy 114 then authenticates the UserID and makes sure that the UserID on the policy 114 belongs to the user attempting to view the object 100. Assuming that the user can be authenticated, the policy 114 continues to get the current time from an approved time service, such as the time service 232 that is illustrated. The policy 114 causes a connection to the time service to be established. The communication interfaces 226 provided by the execution context 502 may assist with establishing the connection. Upon receiving the time from the time service 232, the policy 114 verifies that the current time is earlier than the expiration time. If the current time is earlier, the policy 114 is okay; otherwise, the policy 114 is not okay.

The Log Event policy 115 is then executed. As illustrated by FIG. 3, the Log Event policy 115 gets user parameters, such as, for example, UserID, gets the current time from an approved time service such as the time service 232 illustrated in FIG. 5, and sends the user parameters and the time to a logging service, such as the logging service 234 illustrated in FIG. 5. Presumably, the logging service 234 records the information received from the policy 115 in a log file or database, such that there is a record that the user has viewed the payload 117. As illustrated, the Log Event policy 115 is always okay.

The Log Event policy 115 provides a good example of the flexibility of policies as implemented in these embodiments of policy managed objects. The Log Event policy 115 allows the completion of an administrative task, keeping a log, as part of the policy enforcement process. Simple permissions-based systems, because they do not execute active policy objects but instead merely check permissions records, cannot perform this function.

After the policies are executed, and assuming that they are okay, the Object View lifecycle occurrence method 402 allows the payroll 117 to be viewed. Allowing the payload 117 to be viewed may include providing a valid authentication to the payload container object 104 such that the payload container object 104 can decrypt payload 117.

A Process of Performing an Action on an Object

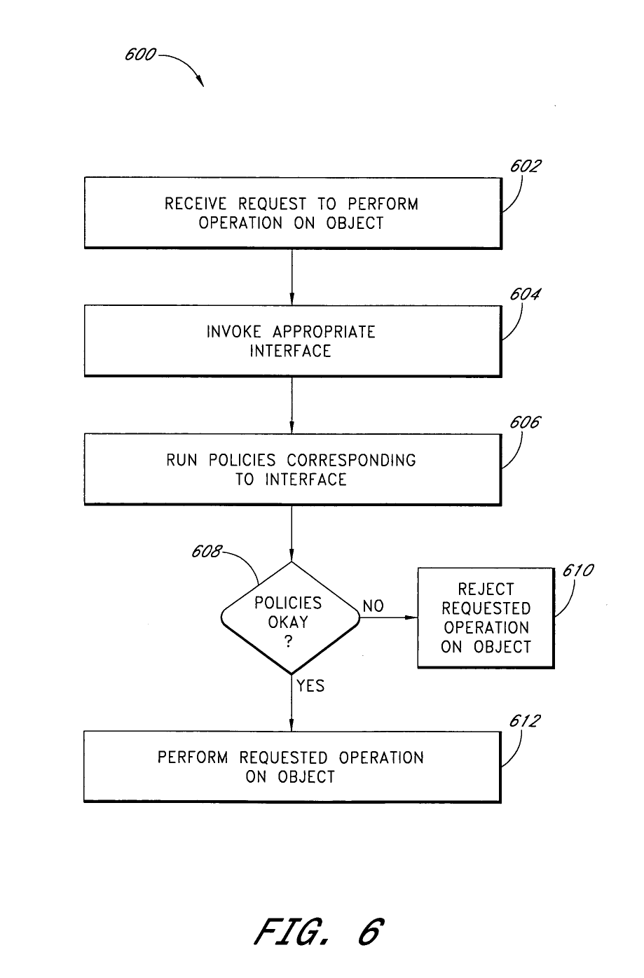

FIG. 6 is a flowchart illustrating a process of performing an action on an object in accordance with embodiments described herein. In a block 602, a request to perform an operation on an object is received. In one embodiment, the request is received by an execution context. Preferably, the request is received in accordance with a well-defined interface of the object. In a block 604, an appropriate lifecycle occurrence method is invoked. Preferably, the lifecycle occurrence method is invoked by the execution context when the execution context determines that a lifecycle occurrence has happened to the object. In a block 606 policies corresponding to the lifecycle occurrence are executed. In one embodiment, the lifecycle occurrence method that has been invoked causes the policies to be executed. In one embodiment, execution of the policies corresponding to the lifecycle occurrence includes performing actions and testing for conditions that are defined by executable instructions within the policy. In one embodiment, performing actions and testing for conditions that are defined by the executable instructions includes accessing services that can be located on the same computer as the policy managed object or can be located on an external computer connected via a computer network. In a decision block 608, a determination is made as to whether the policies are okay. If the policies are not okay, the process 600 proceeds to a block 610, in which the requested operation on the object is rejected and is not performed. If the policies are okay, the process 600 proceeds to a block 612, in which the requested operation on the object is performed.

The systems and methods described herein have been described with reference to various preferred and exemplary embodiments. While the foregoing preferred embodiments are seen to provide certain advantages, many other embodiments are encompassed by the invention. In general, the features described herein with regard to certain embodiments are not required features of the invention. As such, the embodiments described herein are offered for the purpose of providing useful examples of how to practice the invention, not as limitations on the invention. In many cases, features that are part of certain embodiments can be omitted from other embodiments without departing from the scope of the invention. Additionally, a skilled artisan will appreciate, from this disclosure, how to implement variations of the invention that are not explicitly stated herein but which are apparent from the disclosure and the principles described herein. Such variations, in addition to those explicitly described, are encompassed within the scope of the invention.

Claims have been provided herein to define the invention. Each claim provides a full definition of the invention without the importation of additional limitations from this written description. It is anticipated that amended claims may be presented in the future and that such amended claims will also provide a full definition of the invention without the importation of additional limitations from the written description. With that in mind, the claims follow.

What is claimed is:

1. A system for controlling access to policy managed objects by associating with the policy managed objects a number of policy objects that determine whether access to the policy managed object is permitted, the system configured such that:
each policy managed object has a payload container object that securely stores a payload comprising arbitrary data;
each policy managed object has a number of interfaces that define mechanisms for accessing the policy managed object or the payload;
each policy managed object is associated with a number of policy objects;
each policy object has executable instructions that define a policy for determining whether a type of access to an associated policy managed object is permitted, such as a policy in which access is permitted if a user has a license to access a policy managed object, a policy in which access is permitted if the user is using a secure viewer, and a policy in which access is permitted only during business hours;
when a user attempts to access the policy managed object or the payload, such as by invoking one of the interfaces, any policies pertaining to the type of access requested by the user are executed in order to determine whether the access is permitted; and
if the policies determine that the access is permitted, the user is allowed to access the policy managed object or the payload.

2. A system for controlling access to policy managed objects by associating with the policy managed objects a number of policy objects that determine whether access to the policy managed object is permitted, the system configured such that:
each policy managed object has a payload container object that securely stores a payload comprising arbitrary data;
each policy managed object has a number of interfaces that define mechanisms for accessing the policy managed object or the payload;
each policy managed object is associated with a number of policy objects;
each policy object has executable instructions that define a policy for determining whether a type of access to an associated policy managed object is permitted;
when a user attempts to access the policy managed object or the payload any policies pertaining to the type of access requested by the user are executed in order to determine whether the type of access is permitted; and
if the policies determine that the type of access is permitted, the user is allowed to access the policy managed object or the payload.

3. A method of accessing a policy managed object comprising:
receiving a request to access a policy managed object, wherein the policy managed object comprises a payload container object that securely stores a payload of data, a plurality of policy objects, and a plurality of interfaces;
executing at least one policy, wherein the policy is defined by executable instructions in one of the policy objects, in order to determine if, under the circumstances, the requested access of the policy managed object is permitted;
permitting the requested access to the policy managed object if the policies determine that, under the circumstances, the requested access of the policy managed object is permitted; and
denying the requested access to the policy managed object if the policies determine that, under the circumstances, the requested access of the policy managed object is not permitted.

4. A data object comprising:
at least one payload comprising data;
a number of interfaces, each interface configured to perform at least one operation on the data object, wherein no operation is allowed to be performed on the data object except by invocation of one of the interfaces; and
at least one policy object comprising executable instructions configured to make a determination as to whether at least one operation requested to be performed on the object is allowed.

5. The data object of claim 1, wherein the number of interfaces is one.

6. The data object of claim 1, further comprising at least one payload container object configured to securely store the at least one payload such that the at least one payload cannot be operated upon without approval from the at least one payload container.

7. The data object of claim 6, wherein the at least one payload container object securely stores the at least one payload by encrypting the at least one payload.

8. The data object of claim 6, wherein, in response to a request to perform an operation upon the at least one payload, the at least one payload container object grants the request upon a determination from the at least one policy object that the requested operation is allowed.

9. The data object of claim 7, wherein the at least one payload container object decrypts the at least one payload and approves a requested operation upon the at least one payload upon receipt, by the at least one payload container, of a valid authentication.

10. The data object of claim 9, wherein the at least one payload container object receives a valid authentication from the at least one policy object when the at least one policy object determines that the requested operation is allowed.

11. The data object of claim 1, wherein the determination made by the at least one policy object at least partially depends on whether conditions defined by the at least one policy object are satisfied.

12. The data object of claim 11, wherein the at least one policy object is configured to receive input from at least one service, such input contributing at least partially to resolving whether conditions defined by the at least one policy object are satisfied.

13. The data object of claim 1, wherein the at least one policy object comprises, within the at least one policy object, at least one other policy object.

14. An execution context for managing data objects, the execution context comprising:
a storage area configured to store a plurality of policy managed objects, each policy managed object comprising:
at least one payload container object that securely stores at least one payload comprising data;
a number of interfaces, each interface configured to perform at least one operation on the policy managed object, wherein no operation is allowed to be performed on the policy managed object except by invocation of one of the interfaces; and
at least one policy object comprising executable instructions configured to make a determination as to whether at least one operation requested to be performed on the policy managed object is allowed;
and
a plurality of access tools, each access tool configured to cause at least one operation to be performed on at least one of the policy managed objects.

15. The execution context of claim 14, wherein the access tools include a policy editor configured to create and modify policy objects, wherein creating and modifying policy objects includes composing or nesting multiple policy objects together so as to define a composed policy object.

16. The execution context of claim 14, wherein the access tools include an object editor configured to create and modify policy managed objects, wherein creating and modifying policy managed objects includes loading data of arbitrary type into the at least one payload container object.

17. The execution context of claim 14, wherein the access tools are further configured, in response to receipt of a request to perform an operation on an identified policy managed object, to invoke an interface of the identified policy managed object that is configured to perform the requested operation.

18. The execution context of claim 14, wherein the execution context is configured to recognize lifecycle occurrences that happen to the policy managed objects and, in response to a lifecycle occurrence to cause policy objects associated with the policy managed objects to which the lifecycle occurrence happened and associated with the lifecycle occurrence that has happened to determine whether operations to be performed during the lifecycle occurrence are allowed.

19. The execution context of claim 18, wherein the lifecycle occurrences comprise object connection, object activation, object serialization, object copy, and object delete.

20. The execution context of claim 14, wherein the access tools include at least one communication interface configured to provide access to at least one service that is configured to return at least one input that influences the at least one policy object's determination as to whether at least one operation requested to be performed on the policy managed object is allowed.

21. A method of controlling access to a data object, the method comprising:
receiving a request to perform an operation on a data object;
invoking a lifecycle occurrence method that corresponds to the operation to be performed on the data object;
executing at least one policy that corresponds to the lifecycle occurrence method;
determining, based on the execution of the at least one policy, whether performing the requested operation on the data object is allowed; and
performing the requested operation on the data object if the requested operation is allowed.

22. The method of claim 21, wherein the at least one policy that is executed is defined at least in part by executable instructions included in at least one policy object.

23. The method of claim 22, wherein the at least one policy object that defines the at least one policy that is executed resides within the data object upon which the operation is to be performed.

24. The method of claim 21 wherein determining whether performing the requested operation on the data object is allowed comprises determining whether at least one condition defined by the at least one policy is satisfied.

25. The method of claim 24, wherein determining whether performing the requested operation on the data object is allowed further comprises receiving input from a service.
